(19) United States
(12) Patent Application Publication
(10) Pub. No.: US 2023/0383906 A1
(43) Pub. Date: Nov. 30, 2023

(54) OIL SUMP SYSTEM TO STABILIZE OIL SUPPLY

(71) Applicant: Atieva, Inc., Menlo Park, CA (US)

(72) Inventors: Rene Zarikian, Newark, CA (US); Ben Horst, San Jose, CA (US); Enrico Sala, Cupertino, CA (US); Dale Lineaweaver, El Sobrante, CA (US)

(21) Appl. No.: 18/202,556

(22) Filed: May 26, 2023

Related U.S. Application Data
(60) Provisional application No. 63/346,060, filed on May 26, 2022.

(51) Int. Cl. F16N 39/06; F16N 7/38

(52) U.S. Cl. CPC F16N 39/06; F16N 7/38

(57) ABSTRACT

An oil sump system, having a housing, an oil pump capable of pumping oil, an inlet connected to the oil pump via a first piping; a second piping for recirculating oil pumped by the pump back to the housing for use in lubricating internal components housed by the housing, an oil sump fixture comprising a mesh screen; and an oil sump cover. The mesh screen may be positioned above the inlet.

### CROSS-REFERENCE TO RELATED APPLICATIONS

This application claims the benefit of U.S. Provisional Patent Application No. 63/346,060, filed May 26, 2022, the disclosure of which is incorporated herein by reference for any and all purposes.

### FIELD OF THE DISCLOSURE

This disclosure relates generally to oil sump systems, and more specifically to oil sump systems for electric vehicles, in particular race cars, sports cars and other vehicles under high transient G-load conditions.

### BACKGROUND

Vehicles under high transient G-loads, from acceleration or turning under high speeds can experience cavitation or air injection into the oil sump pump intake, which can cause problems with oil distribution throughout the engine. For example, FIG. 1 illustrates a typical prior art system under forward acceleration wherein the G-load from forward acceleration is sufficient to lower the oil levels near the intake within the drive unit housing below the upper lip of the oil pump inlet, which can lead to air ingestion and oil aeration. For example, FIG. 1 illustrates an oil sump pump system having a drive unit housing, with an oil pump inlet 11 having piping 12 that leads to a pump 13 which recirculates oil through return piping 14 where it can be re-delivered to the motor until it gets collected and recirculated back to the inlet 11. Under normal operation, the system may have a normal oil level at 17. However, when the system is subjected to a transient G-load, such as from rapid acceleration or hard cornering, the oil level may be pulled into a triangular shape 17′, which drops below the top lip of the inlet allowing air to be ingested into the oil pump, and which may cause cavitation, oil aeration and other such problems.

The disclosed concepts seek to address this problem utilizing the surface tension properties of oil interacting with a mesh screen.

### BRIEF SUMMARY OF THE DISCLOSURE

The following presents a simplified summary of the disclosure in order to provide a basic understanding of some aspects of the various embodiments disclosed herein. This summary is not an extensive overview of every detail of every embodiment. It is intended to neither identify key or critical elements of every embodiment nor delineate the scope of every disclosed embodiment. Its sole purpose is to present some concepts of disclosure in a simplified form as a prelude to the more detailed description that is presented later.

In an embodiment, an oil sump system may include a housing, an oil pump capable of pumping oil, an inlet connected to the oil pump via a first piping; a second piping for recirculating oil pumped by the pump back to the housing for use in lubricating internal components housed by the housing, an oil sump fixture comprising a mesh screen; and an oil sump cover. The mesh screen may be positioned above the inlet.

In an embodiment an oil sump fixture for an oil sump system may include a main body and a mesh screen. The oil sump fixture may be positionable within the housing of the oil sump system such that the mesh screen may be disposed above an inlet of the oil sump system.

In an embodiment, a vehicle may include n oil sump system having a housing, an oil pump capable of pumping oil, an inlet connected to the oil pump via a first piping, a second piping for recirculating oil pumped by the pump back to the housing for use in lubricating internal components housed by the housing, an oil sump fixture comprising a mesh screen, an oil sump cover. The mesh screen may be positioned above the inlet.

In an embodiment, a method for maintaining oil supply to an oil sump fixture may include: providing a vehicle with an oil sump system that may have a housing, an oil pump capable of pumping oil, an inlet connected to the oil pump via a first piping, a second piping for recirculating oil pumped by the pump back to the housing for use in lubricating internal components housed by the housing, an oil sump fixture comprising a mesh screen, and an oil sump cover. The method may further include positioning the mesh screen above the inlet.

The following description and annexed drawings set forth certain illustrative aspects of the disclosure. These aspects are indicative, however, of but a few of the various ways in which the principles disclosed may be employed. Other advantages and novel features disclosed herein will become apparent from the following description when considered in conjunction with the drawings.

### BRIEF DESCRIPTION OF THE FIGURES

FIG. 1 illustrates a system diagram of a prior art oil sump system.

FIG. 2 illustrates a system diagram of an embodiment of an oil sump system in accordance with the disclosed concepts.

FIG. 3 illustrates a system diagram of the oil sump system of FIG. 2 under a transient G-load.

FIG. 4 illustrates an overhead view of an embodiment of oil topography in accordance with the disclosed concepts.

FIG. 5 illustrates a simplified cross sectional view of a wire mesh in accordance with the disclosed concepts.

FIG. 6 illustrates an overhead photograph of a metal wire mesh and oil in accordance with the disclosed concepts.

FIG. 7 illustrates a topographical map overlay on a photograph of a 100 micron metal wire mesh and oil in accordance with the disclosed concepts.

FIG. 8 illustrates a topographical map overlay on a photograph of a 100 micron nylon wire mesh and oil in accordance with the disclosed concepts.

FIG. 9 illustrates constant-angle test results using various wire meshes in accordance with the disclosed concepts.

FIG. 10 illustrates slosh test results using various wire meshes in accordance with the disclosed concepts.

FIG. 11 illustrates the angle parameters for the slosh test of FIG. 10.

FIG. 12 illustrates an exploded, cross-sectioned perspective view of an oil sump system in accordance with the disclosed concepts.

FIG. 13 illustrates a cross-sectioned perspective view of an oil sump system in accordance with the disclosed concepts.

FIG. 14 illustrates a photograph of an alternative embodiment of an oil sump fixture with mesh frame and mesh screen in accordance with the disclosed concepts.

FIG. 15 illustrates a bottom perspective view of an alternative embodiment of an oil sump mesh frame in accordance with the disclosed concepts.

FIG. 16 illustrates a top perspective view of an alternative embodiment of an oil sump mesh frame in accordance with the disclosed concepts.

### DETAILED DESCRIPTION OF THE DISCLOSURE

The following detailed description and the appended drawings describe and illustrate some embodiments for the purpose of enabling one of ordinary skill in the relevant art to make use the invention. As such, the detailed description and illustration of these embodiments are purely illustrative in nature and are in no way intended to limit the scope of the invention, or its protection, in any manner. It should also be understood that the drawings are not necessarily to scale and in certain instances details may have been omitted, which are not necessary for an understanding of the disclosure, such as details of fabrication and assembly. In the accompanying drawings, like numerals represent like components.

In an embodiment, an oil sump system may include a housing, an oil pump capable of pumping oil, an inlet connected to the oil pump via a first piping; a second piping for recirculating oil pumped by the pump back to the housing for use in lubricating internal components housed by the housing, an oil sump fixture comprising a mesh screen; and an oil sump cover. The mesh screen may be positioned above the inlet.

In certain embodiments, the system may further include oil having an oil level that is above the mesh screen when the oil sump system is at rest, and such that the oil level may be lowered over a portion of the mesh screen when the system is subjected to a transient G-load. When the system is subjected to a first transient G-load such that the oil level of the oil is lowered over a first portion of the mesh screen that is near the inlet, the surface tension created over the oil in the mesh maintains the level of the oil over the first portion of the mesh screen at the mesh screen.

In certain embodiments the system may further include oil having an oil level that is above the mesh screen when the oil sump system is at rest, such that as the oil is pulled into the inlet, air bubbles in the oil are accumulated at nucleation sites on a top surface of the mesh screen such that the air bubbles can aggregate and float to the surface of the oil level, to minimize the amount of the air bubbles that enter the inlet and pass through to the pump.

In certain embodiments the mesh screen may be made of metal. In certain embodiments the mesh screen may be made of stainless steel. In certain embodiments the mesh screen may be made of nylon. In certain embodiments the mesh screen may have openings in the range of approximately 50-600 microns. In certain embodiments the mesh screen may have openings of approximately 73 microns. In certain embodiments the mesh screen may have openings of approximately 125 microns. In certain embodiments the mesh screen may have openings of approximately 590 microns.

In certain embodiments the oil sump fixture may include a frame on which the mesh screen may be disposed. The frame may provide structural support for the mesh screen. In certain embodiments the mesh screen may be sealed to the frame. In certain embodiments the mesh screen may be sealed to the oil sump fixture. In certain embodiments a sealant may be applied to the oil sump fixture. In certain embodiments the sealant may seal the oil sump fixture to the housing. In certain embodiments the sealant may seal the oil sump fixture to the cover.

In an embodiment an oil sump fixture for an oil sump system may include a main body and a mesh screen. The oil sump fixture may be positionable within the housing of the oil sump system such that the mesh screen may be disposed above an inlet of the oil sump system.

In certain embodiments, when the oil sump system may be provided with oil having an oil level that is above the mesh screen when the oil sump system is at rest, and such that the oil level may be lowered over a portion of the mesh screen when the system is subjected to a transient G-load, when the system is subjected to a first transient G-load such that the oil level of the oil is lowered over a first portion of the mesh screen that is near the inlet, the surface tension created over the oil in the mesh maintains the level of the oil over the first portion of the mesh screen at the mesh screen.

In certain embodiments, when the oil sump system may be provided with oil having an oil level that is above the mesh screen when the oil sump system is at rest, such that as the oil is pulled into the inlet, air bubbles in the oil are accumulated at nucleation sites on a top surface of the mesh screen such that the air bubbles can aggregate and float to the surface of the oil level, to minimize the amount of the air bubbles that enter the inlet and pass through to the pump.

In certain embodiments, the mesh screen may be made of metal. In certain embodiments, the mesh screen may be made of stainless steel. In certain embodiments, the mesh screen may be made of nylon. In certain embodiments, the mesh screen may have openings in the range of approximately 50-600 microns. In certain embodiments, the mesh screen may have openings of approximately 73 microns. In certain embodiments, the mesh screen may have openings of approximately 125 microns. In certain embodiments, the mesh screen may have openings of approximately 590 microns.

In certain embodiments, the oil sump fixture may further include a frame on which the mesh screen may be disposed, the frame providing structural support for the mesh screen. In certain embodiments, the mesh screen may be sealed to the frame. In certain embodiments, the mesh screen may be sealed to the oil sump fixture. In certain embodiments, a sealant may be applied to the oil sump fixture. In certain embodiments, the sealant may seal the oil sump fixture to the housing. In certain embodiments, the sealant may seal the oil sump fixture to the cover.

In an embodiment, a vehicle may include n oil sump system having a housing, an oil pump capable of pumping oil, an inlet connected to the oil pump via a first piping, a second piping for recirculating oil pumped by the pump back to the housing for use in lubricating internal components housed by the housing, an oil sump fixture comprising a mesh screen, and an oil sump cover. The mesh screen may be positioned above the inlet.

In certain embodiments, the oil sump system may further include oil having an oil level that is above the mesh screen when the oil sump system is at rest, and such that the oil level may be lowered over a portion of the mesh screen when the system is subjected to a transient G-load. When the system is subjected to a first transient G-load such that the oil level of the oil is lowered over a first portion of the mesh screen that is near the inlet, the surface tension created over the oil in the mesh maintains the level of the oil over the first portion of the mesh screen at the mesh screen.

In certain embodiments, the oil sump system may further include oil having an oil level that is above the mesh screen when the oil sump system is at rest, such that as the oil is pulled into the inlet, air bubbles in the oil are accumulated at nucleation sites on a top surface of the mesh screen such that the air bubbles can aggregate and float to the surface of the oil level, to minimize the amount of the air bubbles that enter the inlet and pass through to the pump.

In certain embodiments, the mesh screen may be made of metal. In certain embodiments, the mesh screen may be made of stainless steel. In certain embodiments, the mesh screen may be made of nylon. In certain embodiments, the mesh screen may have openings in the range of approximately 50-600 microns. In certain embodiments, the mesh screen may have openings of approximately 73 microns. In certain embodiments, the mesh screen may have openings of approximately 125 microns. In certain embodiments, the mesh screen may have openings of approximately 590 microns.

In certain embodiments, the oil sump fixture may further include a frame on which the mesh screen may be disposed, the frame providing structural support for the mesh screen. In certain embodiments, the mesh screen may be sealed to the frame. In certain embodiments, the mesh screen may be sealed to the oil sump fixture. In certain embodiments, a sealant may be applied to the oil sump fixture. In certain embodiments, the sealant may seal the oil sump fixture to the housing. In certain embodiments, the sealant may seal the oil sump fixture to the cover.

In an embodiment, a method for maintaining oil supply to an oil sump fixture may include: providing a vehicle with an oil sump system that may have a housing, an oil pump capable of pumping oil, an inlet connected to the oil pump via a first piping, a second piping for recirculating oil pumped by the pump back to the housing for use in lubricating internal components housed by the housing, an oil sump fixture comprising a mesh screen, and an oil sump cover. The method may further include positioning the mesh screen above the inlet.

In certain embodiments, the method may further include providing oil to the oil sump system having an oil level that is above the mesh screen when the oil sump system is at rest, and such that the oil level may be lowered over a portion of the mesh screen when the system is subjected to a transient G-load, and subjecting the oil sump system to a first transient G-load such that the oil level of the oil is lowered over a first portion of the mesh screen that is near the inlet, the surface tension created over the oil in the mesh maintains the level of the oil over the first portion of the mesh screen at the mesh screen.

In certain embodiments, the method may further include providing oil to the oil sump system having an oil level that is above the mesh screen when the oil sump system is at rest, and operating the vehicle such that as the oil is pulled into the inlet, air bubbles in the oil are accumulated at nucleation sites on a top surface of the mesh screen such that the air bubbles can aggregate and float to the surface of the oil level, to minimize the amount of the air bubbles that enter the inlet and pass through to the pump.

In certain embodiments, the mesh screen may be made of metal. In certain embodiments, the mesh screen may be made of stainless steel. In certain embodiments, the mesh screen may be made of nylon. In certain embodiments, the mesh screen may have openings in the range of approximately 50-600 microns. In certain embodiments, the mesh screen may have openings of approximately 73 microns. In certain embodiments, the mesh screen may have openings of approximately 125 microns. In certain embodiments, the mesh screen may have openings of approximately 590 microns.

In certain embodiments, the oil sump fixture may include a frame on which the mesh screen may be disposed, the frame providing structural support for the mesh screen. In certain embodiments, the mesh screen may be sealed to the frame. In certain embodiments, the mesh screen may be sealed to the oil sump fixture. In certain embodiments, a sealant may be applied to the oil sump fixture. In certain embodiments, the sealant may seal the oil sump fixture to the housing. In certain embodiments, the sealant may seal the oil sump fixture to the cover.

FIG. 2 illustrates an embodiment of an oil sump system in accordance with the disclosed concepts. Oil sump system 10 may include a drive housing 18, an inlet 11, inlet piping 12 leading to a pump 13, and recirculation piping 14 leading back to the drive housing 18 to deliver oil to the internal components of same (not shown). The system 10 may further have a mesh screen 15 disposed a distance above the inlet 11. The mesh screen may be provided with a seal 16 at its outer boundaries to seal it to the a portion of the drive housing 18, a frame [##], or At rest, and/or during normal operation, the system may have an amount of oil having a resting level 17 that lies above pump inlet 11 and above the mesh screen 15. As discussed in greater detail below with respect to FIGS. 12-17, the mesh screen 15 may be provide with framing or disposed on a frame to provide it with structural support.

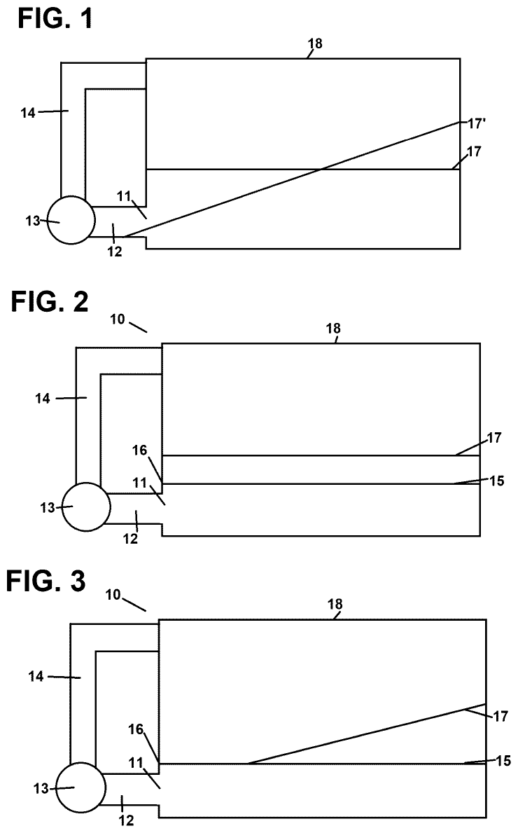

FIG. 3 illustrates a system diagram of the oil sump system of FIG. 2 under a transient G-load. When a transient G-load, such as rapid acceleration or high speed turns, is applied to the system 10, the G-load pushes the oil level 17 in the direction that the transient G-Load is being applied. Where, as in FIGS. 1 and 3, the transient G-load is applied in a direction away from the inlet 11, the oil level 17 (17′ in FIG. 1) is pushed in that direction to form an angular slope. In such circumstances the mesh screen 15 serves to trap oil in the holes between the mesh screen components (metal wires, nylon strings, or any other suitable material). The surface tension of the oil in the mesh screen 15 helps to maintain the oil level 17 near the inlet at the mesh screen 15, and above the inlet to prevent the entry of air into the inlet piping 12 and into the pump.

An additional benefit of the disclosed concept relates to filtration of air bubbles from the oil as it passes through the mesh screen. As oil is recirculated by the oil sump pump, air bubbles are introduced into the oil supply. As the oil is pulled through the mesh screen towards the inlet, the air bubbles accumulate at the surface of the mesh screen, which acts as a filter for same. This creates nucleation sites, where air bubbles in the oil collect and accumulate above the mesh until they can float to the top of the mesh and pop thereby releasing the air into the housing. In this manner, the amount of air bubbles that are introduced into the pump is minimized and/or eliminated, which reduces the foaming of oil, and helps to maintain oil supply to the system.

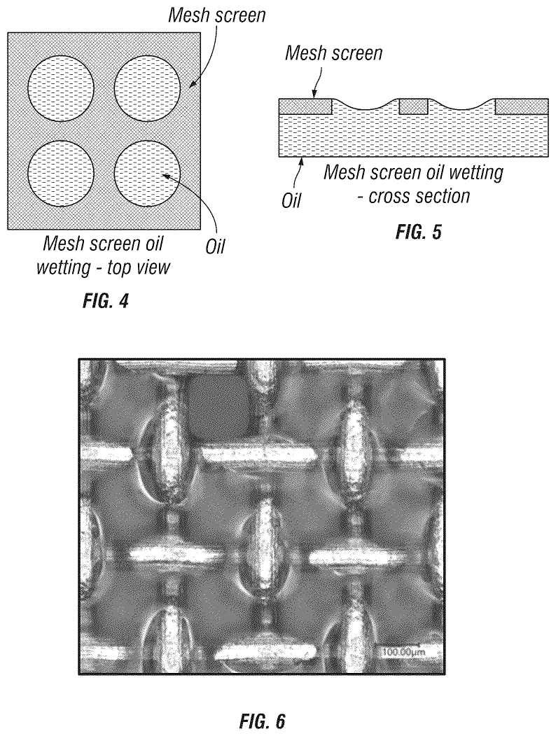

The principle of operation relies on the delicate balance between the surface tension of the fluid and its viscosity. When the mesh is “wet” and a transient load pushes the oil level 17 to the mesh screen 15 at at least a portion of the mesh screen, surface tension may create an uninterrupted web of oil that effectively seals the openings of the mesh. FIGS. 4-6 depict the oil wetting these openings. FIG. 5 shows what the expected cross section of the mesh would look like with oil underneath. The meniscuses show the surface tension of the oil creating a web of oil sealing the openings.

FIG. 4 illustrates an overhead view of an embodiment of oil topography in accordance with the disclosed concepts. The mesh screen 15 material, whether metal wires, nylon strings or another suitable material, may create pockets of oil in the mesh having a generally circular topography.

FIG. 5 illustrates a simplified cross-sectional view of a wire mesh in accordance with the disclosed concepts. The pockets of oil formed in the mesh screen 15 between the mesh material, when the system 10 is under a G-load, may have a surface having a concave shape when viewed from the side.

FIG. 6 illustrates an overhead photograph of a metal wire mesh screen 15 and oil in accordance with the disclosed concepts. The surface 17 of the oil in the mesh can be seen forming pockets of oil in the holes formed between the metal wires of the mesh screen 15.

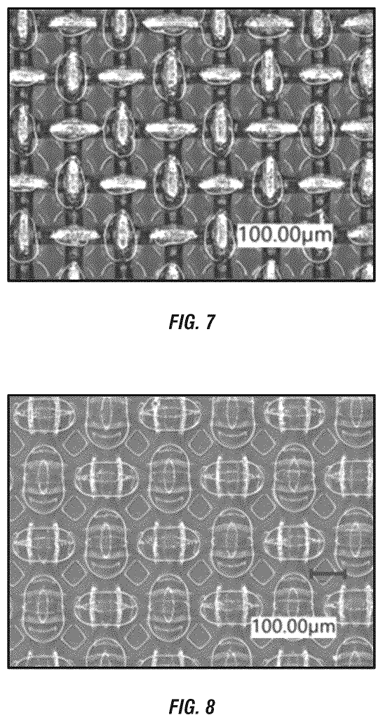

FIGS. 7-8 illustrate topographical map overlays on overhead photographs of a 100 micron mesh made from metal wire and nylon, respectively.

FIG. 7 illustrates a topographical map overlay on a photograph of a 100 micron metal wire mesh and oil in accordance with the disclosed concepts.

FIG. 8 illustrates a topographical map overlay on a photograph of a 100 micron nylon wire mesh and oil in accordance with the disclosed concepts.

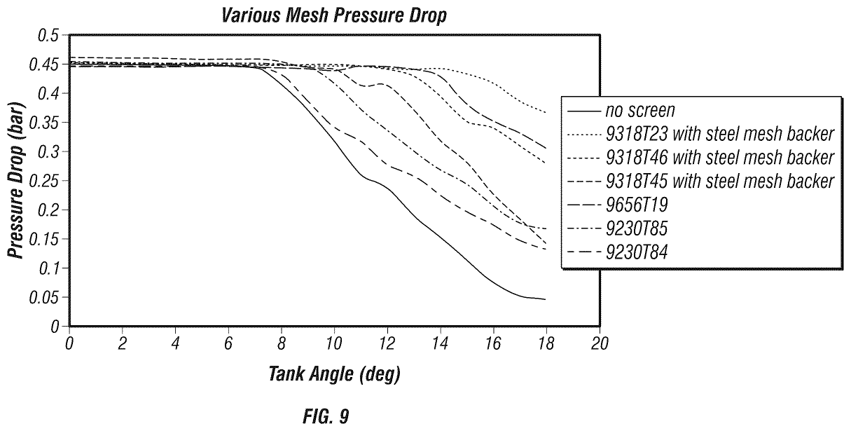

To evaluate optimal mesh size for an embodiment of the disclosed concepts, various meshes were tested. FIG. 9 illustrates constant-angle test results using various wire meshes in accordance with the disclosed concepts. To simulate a transient G-load, a test buck having a resting oil level 17 above a mesh screen 15 was tilted to various angles, and the drop in oil pressure at the inlet was monitored. The test was then repeated with various meshes. All meshes tested showed significant improvement in reducing the measured pressure drop. The meshes tested were as follows:

| Part No. | Material | Opening size (μm) | Open area |
|---|---|---|---|
| 9318T23 | Nylon w/metal frame | 125 | 39% |
| 9318T46 | Nylon w/metal frame | 99 | 47% |
| 9318T45 | Nylon w/metal frame | 300 | 51% |
| 9656T19 | Stainless Steel | 73 | 38% |
| 9230T85 | Stainless Steel | 84 | 34% |
| 9230T84 | Stainless Steel | 96 | 37% |

The best performing mesh screens 15 in the constant-angle test were the 9318T23, with a metal frame backing and the 9656T19 meshes.

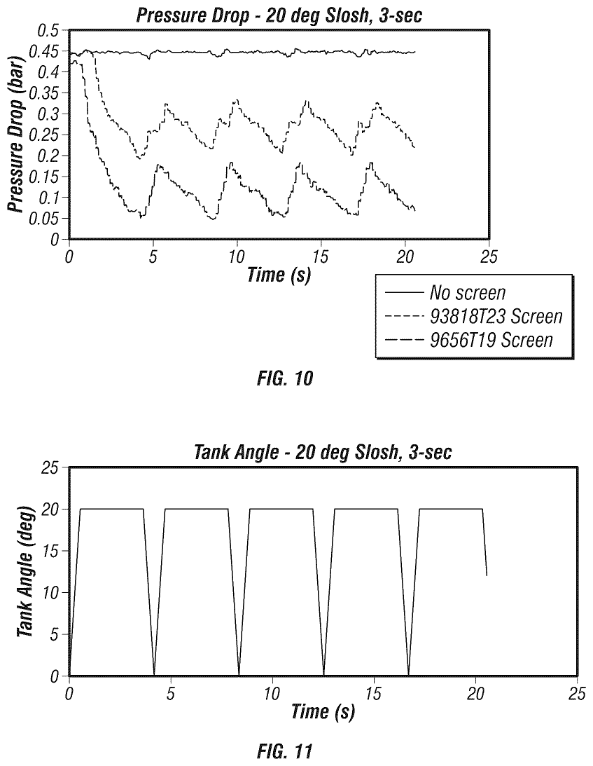

A second, “slosh” test was then run on the best performing meshes from the constant-angle test. In the slosh test, the test buck with the screens was quickly moved from a resting position to a twenty (20°) degree angle, held there for a time and then quickly moved back to rest and again to the twenty-degree angle several times. The oil pressure at the inlet was monitored during the test. FIG. 10 illustrates slosh test results using various wire meshes in accordance with the disclosed concepts, where the 9656T19 mesh outperformed the 9318T23.

The ideal mesh size for any given embodiment may vary depending on many factors, including but not limited to the type of oil used in the system, the flow rate of oil through the inlet, the distance of the mesh from the inlet. Ideal mesh size may also require a balancing of surface tension against the amount of oil flow through the mesh that is required. Generally smaller holes in a mesh screen 15 are better for preserving surface tension of the oil in the holes, while larger holes in a mesh screen allow more oil to flow through the mesh. In some implementations, it may be advantageous to use a mesh screen 15 with holes measuring between 50-600 microns. In some implementations, it may be advantageous to use a mesh screen 15 with holes measuring 73 microns. In some implementations, it may be advantageous to use a mesh screen 15 with holes measuring 125 microns. In some implementations, it may be advantageous to use a mesh screen with holes measuring 590 microns.

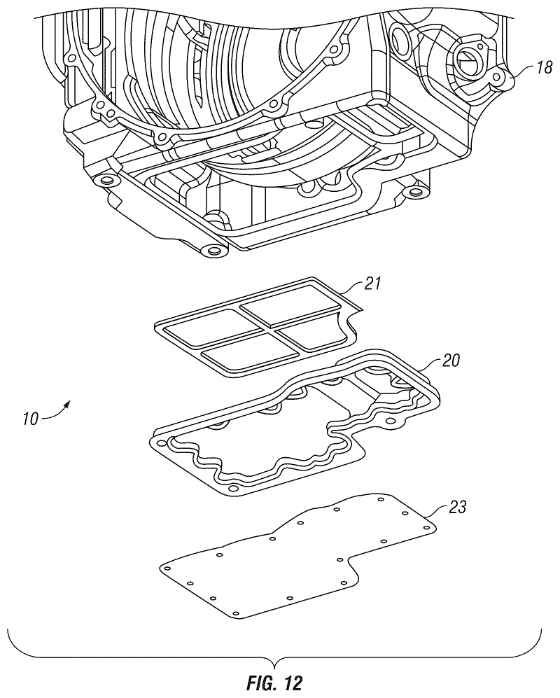

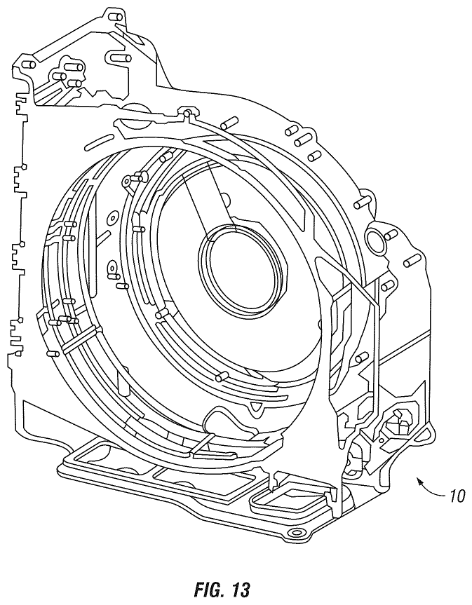

FIG. 11 illustrates the angle parameters for the slosh test of FIG. 10, showing the length of time in which the test buck was held at 20 degrees and the speed with which it was moved between rest and 20 degrees.

FIG. 12 illustrates an exploded, cross-sectioned perspective view of an embodiment of an oil sump system in accordance with the disclosed concepts. In this exemplary embodiment, the oil sump system 10 may include a housing 18, an oil sump fixture 20, a main body 21, an oil sump cover 23. The main body 21 may be provided with a mesh screen 15 (not shown in FIG. 12), in accordance with the disclosed concepts. The mesh frame may be fixedly connected to the oil sump fixture with a sealant (such as RTV paste or other suitable sealants), mechanical connection (such as bots, crimps, welded connections, and other suitable mechanical connections), and/or other methods known in the art or to be discovered. The oil sump cover 23 may be connected to the oil sump fixture 20 by bolts, other mechanical connections and/or other methods and devices known in the art or to be discovered.

FIG. 13 illustrates a cross-sectioned perspective view of the oil sump system 10 of FIG. 12, fully assembled.

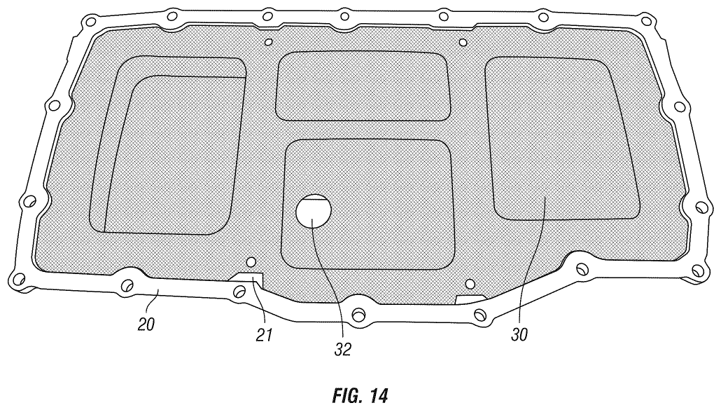

FIG. 14 illustrates a photograph of an alternative embodiment of an oil sump fixture with mesh frame and mesh screen in accordance with the disclosed concepts. The embodiment is designed for a dual motor system having a central oil pump inlet. Oil sump fixture 20 may include a main body 21 and a mesh screen 30. The mesh screen may be provided with a cutout 32, to allow the oil sump pump 13 inlet to be attached. Testing of this embodiment led to the selection of a590 micron mesh for this implementation.

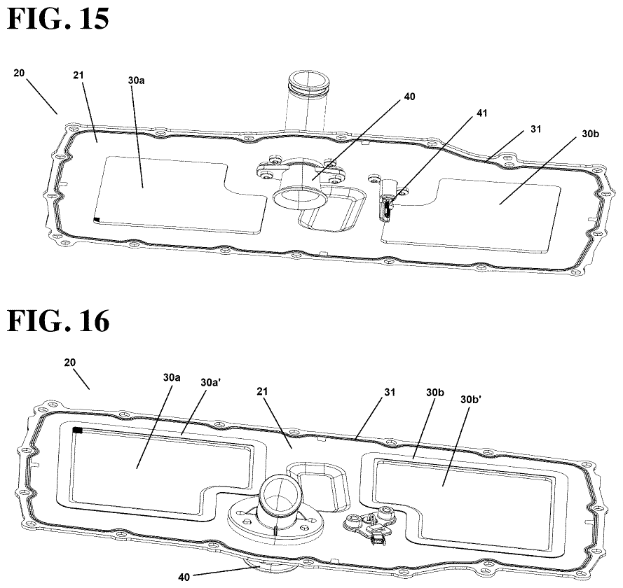

FIGS. 15 & 16 illustrate an alternative embodiment of an oil sump fixture in accordance with the disclosed concepts. FIG. 15 illustrates a bottom perspective view of the oil sump fixture 20. FIG. 16 illustrates a top perspective view of the oil sump fixture 20. Oil sump fixture 20 may include a main body 21, having cutouts around which mesh screens 30a, 30b may be attached. Mesh screens 30a, 30b may be provided with an outer rim 30a′, 30b′ which extend past the cutouts allowing the mesh screens 30a, 30b to be attached to the main body 21 via adhesives, mechanical methods, bolts, welds, and/or other methods known in the art or to be discovered. FIGS. 15 and 16 further show the oil sump fixture with the pump inlet 40 and a temperature sensor 41 attached to the oil sump fixture 20. A sealant 31 may be applied to the outer rim of the main body 21 to seal the oil sump fixture to the housing 18 and/or to the oil sump cover 23.

The descriptions set forth above are meant to be illustrative and not limiting. Various modifications to the disclosed embodiments, in addition to those described herein, will be apparent to those skilled in the art from the foregoing description. Such modifications are also intended to fall within the scope of the concepts described herein. The disclosures of each patent, patent application, and publication cited or described in this document are hereby incorporated herein by reference, in their entireties.

The foregoing description of possible implementations consistent with the present disclosure does not represent a comprehensive list of all such implementations or all variations of the implementations described. The description of some implementations should not be construed as an intent to exclude other implementations described. For example, artisans will understand how to implement the disclosed embodiments in many other ways, using equivalents and alternatives that do not depart from the scope of the disclosure. Moreover, unless indicated to the contrary in the preceding description, no particular component described in the implementations is essential to the invention. It is thus intended that the embodiments disclosed in the specification be considered illustrative, with a true scope and spirit of invention being indicated by the following claims.

What is claimed:

1. An oil sump system comprising:
a housing;
an oil pump capable of pumping oil;
an inlet connected to the oil pump via a first piping;
a second piping for recirculating oil pumped by the pump back to the housing for use in lubricating internal components housed by the housing;
an oil sump fixture comprising a mesh screen;
an oil sump cover;
wherein the mesh screen is positioned above the inlet.

2. The oil sump system of claim 1 further comprising:
oil having an oil level that is above the mesh screen when the oil sump system is at rest, and such that the oil level may be lowered over a portion of the mesh screen when the system is subjected to a transient G-load;
wherein when the system is subjected to a first transient G-load such that the oil level of the oil is lowered over a first portion of the mesh screen that is near the inlet, the surface tension created over the oil in the mesh maintains the level of the oil over the first portion of the mesh screen at the mesh screen.

3. The oil sump system of claim 1 further comprising:
oil having an oil level that is above the mesh screen when the oil sump system is at rest, such that as the oil is pulled into the inlet, air bubbles in the oil are accumulated at nucleation sites on a top surface of the mesh screen such that the air bubbles can aggregate and float to the surface of the oil level, to minimize the amount of the air bubbles that enter the inlet and pass through to the pump.

4. The oil sump system of claim 1 wherein the mesh screen is made of nylon.

5. The oil sump system of claim 1 wherein the mesh screen comprises openings in the range of approximately 50-600 microns.

6. The oil sump system of claim 1 wherein the oil sump fixture further comprises a frame on which the mesh screen is disposed, the frame providing structural support for the mesh screen.

7. The oil sump system of claim 1 wherein the mesh screen is sealed to the oil sump fixture.

8. The oil sump system of claim 1 wherein a sealant is applied to the oil sump fixture.

9. The oil sump system of claim 8 wherein the sealant seals the oil sump fixture to the housing.

10. The oil sump system of claim 8 wherein the sealant seals the oil sump fixture to the cover.

11. An oil sump fixture for an oil sump system comprising:
a main body; and
a mesh screen, such that the oil sump fixture is positionable within the housing of the oil sump system such that the mesh screen is disposed above an inlet of the oil sump system.

12. The oil sump fixture of claim 11 wherein when the oil sump system is provided with oil having an oil level that is above the mesh screen when the oil sump system is at rest, and such that the oil level may be lowered over a portion of the mesh screen when the system is subjected to a transient G-load, such that when the system is subjected to a first transient G-load such that the oil level of the oil is lowered over a first portion of the mesh screen that is near the inlet, the surface tension created over the oil in the mesh maintains the level of the oil over the first portion of the mesh screen at the mesh screen.

13. The oil sump fixture of claim 11 wherein when the oil sump system is provided with oil having an oil level that is above the mesh screen when the oil sump system is at rest, such that as the oil is pulled into the inlet, air bubbles in the oil are accumulated at nucleation sites on a top surface of the mesh screen such that the air bubbles can aggregate and float to the surface of the oil level, to minimize the amount of the air bubbles that enter the inlet and pass through to the pump.

14. The oil sump fixture of claim 11 wherein the mesh screen is made of nylon.

15. The oil sump fixture of claim 11 wherein the mesh screen comprises openings in the range of approximately 50-600 microns.

16. The oil sump fixture of claim 11 further comprising a frame on which the mesh screen is disposed, the frame providing structural support for the mesh screen.

17. The oil sump fixture of claim 11 wherein the mesh screen is sealed to the oil sump fixture.

18. The oil sump fixture of claim 11 wherein a sealant is applied to the oil sump fixture.

19. The oil sump fixture of claim 18 wherein the sealant seals the oil sump fixture to the housing.

20. The oil sump fixture of claim 18 wherein the sealant seals the oil sump fixture to the cover.

21. A vehicle comprising:
an oil sump system having
a housing;
an oil pump capable of pumping oil;
an inlet connected to the oil pump via a first piping;
a second piping for recirculating oil pumped by the pump back to the housing for use in lubricating internal components housed by the housing;
an oil sump fixture comprising a mesh screen;
an oil sump cover;
wherein the mesh screen is positioned above the inlet.

22. The vehicle of claim 21 wherein the oil sump system further comprises:
oil having an oil level that is above the mesh screen when the oil sump system is at rest, and such that the oil level may be lowered over a portion of the mesh screen when the system is subjected to a transient G-load;
wherein when the system is subjected to a first transient G-load such that the oil level of the oil is lowered over a first portion of the mesh screen that is near the inlet, the surface tension created over the oil in the mesh maintains the level of the oil over the first portion of the mesh screen at the mesh screen.

23. The vehicle of claim 21 wherein the oil sump system further comprises:
oil having an oil level that is above the mesh screen when the oil sump system is at rest, such that as the oil is pulled into the inlet, air bubbles in the oil are accumulated at nucleation sites on a top surface of the mesh screen such that the air bubbles can aggregate and float to the surface of the oil level, to minimize the amount of the air bubbles that enter the inlet and pass through to the pump.

24. The vehicle of claim 21 wherein the mesh screen is made of nylon.

25. The vehicle of claim 21 wherein the mesh screen comprises openings in the range of approximately 50-600 microns.

26. The vehicle of claim 21 wherein the oil sump fixture further comprises a frame on which the mesh screen is disposed, the frame providing structural support for the mesh screen.

27. The vehicle of claim 21 wherein the mesh screen is sealed to the oil sump fixture.

28. The vehicle of claim 21 wherein a sealant is applied to the oil sump fixture.

29. The vehicle of claim 28 wherein the sealant seals the oil sump fixture to the housing.

30. The vehicle of claim 28 wherein the sealant seals the oil sump fixture to the cover.
